(19) United States
(12) Patent Application Publication
(10) Pub. No.: US 2025/0266644 A1
(43) Pub. Date: Aug. 21, 2025

(54) PLUG CONNECTOR HAVING IMPROVED OPERATIONAL RELIABILITY AT HIGH ELECTRICAL VOLTAGES

(71) Applicant: HARTING ELECTRIC STIFTUNG & CO. KG, Espelkamp (DE)

(72) Inventor: Norbert KROPIEWNICKI, Bielefeld (DE)

(21) Appl. No.: 19/045,450

(22) Filed: Feb. 4, 2025

(30) Foreign Application Priority Data
Feb. 15, 2024 (DE) 10 2024 104 290.7

(51) Int. Cl. H01R 13/53; H01R 4/18; H01R 13/502

(52) U.S. Cl. CPC H01R 13/53; H01R 4/183; H01R 13/502

(57) ABSTRACT

A plug connector is provided, exhibiting a plug-connector housing, an insulating body and at least one two-part contact element, consisting of a coupling part and a contact part, the plug connector further exhibiting a partial-discharge sleeve, and the coupling part of the contact element being arranged at least partially within the partial-discharge sleeve.

### BACKGROUND

### Technical Field

The present disclosure is related to plug connectors, such as plug connectors that are employed, in particular, in the railway industry for the purpose of transmitting high currents, and/or in connection with the application of high voltages. The contact elements of plug connectors of such a type are often exposed to a current intensity of a thousand amperes and more.

### Description of the Related Art

DE 10 2019 132 127 A1 presents an electrical contact element for transmitting high currents, the electrical contact element being formed in two parts, one part being capable of being plugged, or inserted, into the other, and the two parts being oriented orthogonally to one another.

By reason of the resulting complex geometry of the contact element, a so-called partial discharge may occur locally, particularly in the coupling region, or crimp region.

### BRIEF SUMMARY

Embodiments of the present disclosure provide a plug connector for the application of high currents and/or voltages, in which partial discharges are avoided as far as possible.

The plug connector according to embodiments of the present disclosure exhibit at least one plug-connector housing, an insulating body and at least one two-part contact element consisting of a coupling part and a contact part.

The insulating body is arranged within the plug connector. The plug-connector housing may comprise or consist of an electrically conducting material, in particular of metal.

The plug connector according to embodiments of the disclosure exhibit a partial-discharge sleeve. The coupling part of the contact element is arranged at least partially within the partial-discharge sleeve.

By virtue of the encasing of the coupling part of the contact element by the partial-discharge sleeve, a uniform potential arises in the interior of the partial-discharge sleeve. By virtue of the partial-discharge sleeve, the contact element is given a more homogeneous surface overall, in particular a roundish and flat surface without adjacent air gaps. Accordingly, partial discharges are effectively avoided, and a higher operating voltage of the plug connector is made possible.

On one side, the coupling part may exhibit an axial opening which takes the form of a crimp coupling for an electrical conductor. At the other end, the coupling part may exhibit a radial passage opening into which the contact part is capable of being inserted. The contact part may take the form, for instance, of a pin contact.

A peripheral contact strip may be arranged within the passage opening. Accordingly, a reliable electrical contact between the coupling part and the contact part may be guaranteed.

The inner partial-discharge sleeve may be adapted to the geometry of the coupling part of the contact element. Advantageously, the partial-discharge sleeve is substantially cylindrical.

The partial-discharge sleeve may exhibit an insertion opening. The coupling part may be inserted into the insertion opening into the interior of the partial-discharge sleeve. The partial-discharge sleeve may further exhibit a contact opening which correlates with the passage opening of the coupling part.

Advantageously, the partial-discharge sleeve may comprise or consist of an electrically conducting material, in particular of metal. As a result, the partial-discharge sleeve may constitute with the contact element an electrically conducting unit.

In an advantageous embodiment, the partial-discharge sleeve may comprise or consist of aluminum. This choice of material has proved particularly advantageous in tests.

On the outside, the partial-discharge sleeve may be sheathed by a non-conducting material. In this way, a homogeneous transition to the insulating body may be provided.

The non-conducting material may be applied to the partial-discharge sleeve in an injection-molding method. This method is particularly inexpensive.

### BRIEF DESCRIPTION OF THE SEVERAL VIEWS OF THE DRAWINGS

An embodiment of the disclosure is represented in the drawings and will be elucidated in more detail in the following.

FIG. 1 shows a perspective sectional representation of a plug connector according to an embodiment of the disclosure,

FIG. 2 shows a perspective representation of a coupling part of a contact element of the plug connector, and

FIG. 3 shows a sectional representation of the coupling part of the contact element of the plug connector.

Some of the Figures may contain simplified, schematic representations. In part, identical reference symbols are used for like but possibly not identical elements. Various views of like elements might have been scaled differently. Directional indications, such as, for instance, “left,” “right,” “up” and “down,” are to be understood with reference to the respective Figure and may vary in the individual representations with respect to the object represented.

### DETAILED DESCRIPTION

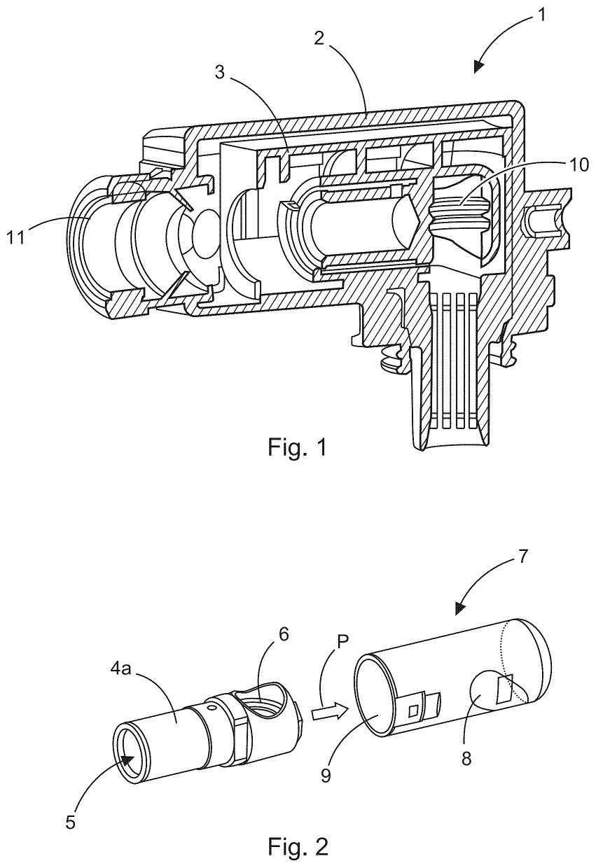

FIG. 1 shows a sectional representation of a plug connector 1 configured in accordance with an embodiment of the present disclosure. The plug connector 1 exhibits a plug-connector housing 2 in which an insulating body 3 is arranged. The plug-connector housing 2 may comprise or consist substantially of aluminum.

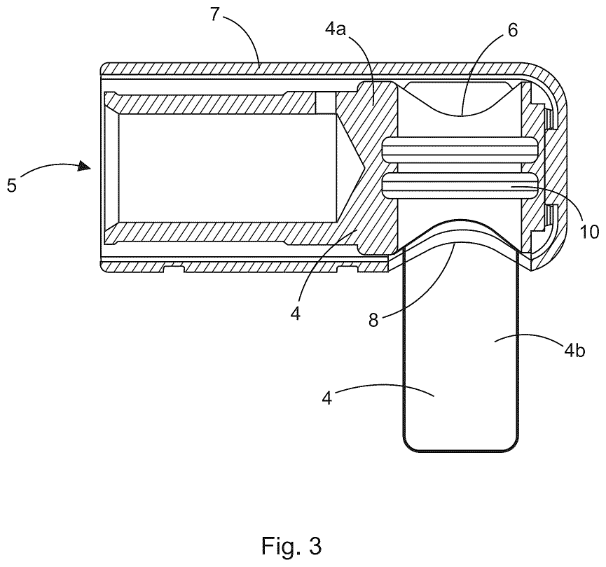

A two-part contact element 4, comprising or consisting of a coupling part 4a and a contact part 4b, is arranged within the insulating body 3. At one end, the coupling part 4a exhibits an axial opening 5 which is provided as a crimp coupling for coupling an electrical conductor (not shown). At the other end, the coupling part 4a exhibits a radial passage opening 6 into which the contact part 4b is capable of being inserted or passed. The geometry of the contact part 4b is not essential for the disclosure, so the contact part 4b has only been represented schematically in FIG. 3.

The coupling part 4a and the contact part 4b of the contact element 4 are arranged to be substantially orthogonal to one another. As a result, the plug connector 1 may be of angled construction, the cable-coupling direction and the plug-in direction intersecting at an angle of 90°.

The plug connector 1 according to the illustrated embodiment of the present disclosure exhibits a partial-discharge sleeve 7 which is represented separately in FIG. 2. In the assembled state, the coupling part 4a of the contact element 4 is arranged within the partial-discharge sleeve 7.

The partial-discharge sleeve 7 exhibits an insertion opening 9. The coupling part 4a can be inserted into the partial-discharge sleeve 7 in the direction of the arrow P. The partial-discharge sleeve 7 exhibits a contact opening 8 which correlates with the passage opening 6 of the coupling part 4a. By this way, the contact part 4b can continue to be inserted into the coupling part 4a.

A peripheral contact strip 10 is arranged within the passage opening 6 of the coupling part 4a. By virtue of the contact strip 10, a reliable electrically conducting connection between the coupling part 4a and the contact part 4b may be established.

The partial-discharge sleeve 7 has been configured substantially as an open hollow cylinder. The partial-discharge sleeve 7 may comprise or consist of aluminum and therefore—in some embodiments—of the same material as the plug-connector housing 2 of the plug connector 1. On the outside, the partial-discharge sleeve 7 has been extrusion-coated with a synthetic material.

On the cable-coupling side, the plug connector 1 exhibits a cable outlet 11 which performs a sealing and strain-relieving function for the coupled cable (not shown).

Even though various aspects or features of the disclosure have been shown in the Figures in combination in each instance, to a person of ordinary skill in the relevant art it is obvious—unless stated otherwise—that the combinations represented and discussed are not the only ones possible. In particular, units or complexes of features corresponding to one another from differing embodiments can be interchanged with one another. In other words, aspects of the various embodiments described above can be combined to provide further embodiments.

German patent application no. 10 2024 104 290.7, filed Feb. 15, 2024, to which this application claims priority, is hereby incorporated herein by reference in its entirety.

In general, in the following claims, the terms used should not be construed to limit the claims to the specific embodiments disclosed in the specification and the claims, but should be construed to include all possible embodiments along with the full scope of equivalents to which such claims are entitled.

1. A plug connector, comprising a plug-connector housing, an insulating body and at least one two-part contact element that includes a coupling part and a contact part, the plug connector further comprising a partial-discharge sleeve, and the coupling part of the contact element being arranged at least partially within the partial-discharge sleeve.

2. The plug connector according to claim 1, wherein at one end, the coupling part exhibits an axial opening in the form of a crimp coupling for an electrical conductor, and wherein at the other end the coupling part exhibits a radial passage opening into which the contact part is insertable.

3. The plug connector according to claim 2, wherein at least one peripheral contact strip is arranged within the radial passage opening.

4. The plug connector according to claim 1, wherein the partial-discharge sleeve is substantially cylindrical.

5. The plug connector according to claim 1, wherein the partial-discharge sleeve exhibits an insertion opening through which the coupling part of the contact element is insertable into the partial-discharge sleeve, and wherein the partial-discharge sleeve exhibits a contact opening which correlates with the radial passage opening of the coupling part.

6. The plug connector according to claim 1, wherein the partial-discharge sleeve consists of an electrically conducting material.

7. The plug connector according to claim 6, wherein the partial-discharge sleeve consists of aluminum.

8. The plug connector according to claim 1, wherein the partial-discharge sleeve is sheathed by a non-conducting material.

9. The plug connector according to claim 8, wherein the non-conducting material has been applied to the partial-discharge sleeve in an injection-molding method.

10. The plug connector according to claim 1, wherein the plug-connector housing consists of an electrically conducting material.

11. The plug connector according to claim 10, wherein the plug-connector housing consists of aluminum.
